(19) United States
(12) Patent Application Publication
(10) Pub. No.: US 2003/0226320 A1
(43) Pub. Date: Dec. 11, 2003

(54) Retrofit window frame and method

(76) Inventor: David J. Engebretson, Gig Harbor, WA (US)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/194,955

(22) Filed: Jul. 11, 2002

Related U.S. Application Data
(60) Provisional application No. 60/387,105, filed on Jun. 7, 2002.

(51) Int. Cl. E06B 3/00

(52) U.S. Cl. 52/204.5

(57) ABSTRACT

A retrofit building window frame is provided for supplementing single-paned, aluminum frames. The frame has a portion which resides on top of the existing aluminum frame. The retrofit frame has forwardly and/or rearwardly extending pockets to receive trim pieces and/or cowlings to cover portions of the existing frame, the existing window liner or both.

### CROSS-REFERENCE TO RELATED APPLICATION

This application claims the benefit of the Jun. 7, 2002 filing date of the prior-filed, co-pending U.S. Provisional Patent Application Serial No. 60/387,105 entitled, “Replacement Window Frame”.

### TECHNICAL FIELD

The invention relates to architectural window frames. More specifically, the invention relates to retrofit window frames and methods for their installation.

### BACKGROUND OF THE INVENTION

After the Second World War, old-style wooden window frames were largely phased out in new home construction in the United States in favor of pre-fabricated, single-paned aluminum frames. The basic structural design of these aluminum frames, generally indicated at reference numeral 1, and illustrated in cross-section in FIG. 2, includes an inner, mounting portion 2 of the frame designed to mount within a “rough” window housing 3, and an outer portion 4 of equal width (about 19 mm) as the inner portion. The inner and outer portions of the frame are separated at a cross-sectional midpoint of the frame by a nailing flange 5 extending from the outside periphery of the frame for securing the frame to the housing.

The prior art aluminum frames 1 were designed for installation into “rough” window housings 3 made up of 2×4 inch (50 mm×100 mm) studs 6, or like materials, covered externally by a sheathing, insulating, or sub-siding layer 7 and occasionally a sub-sill, jamb or header 12a. To install the frame, the frame was partially inserted into the window housing so that the inner, mounting portion 2 overlapped the sub-sill, jamb and header and partially overlapped the stud. To secure the frame within the housing, a nail 10 was then driven through the nailing flange 5 into the stud.

After installation of the aluminum frame 1 was thus completed, the outside of the window housing 3 was “finished” by securing a layer of siding material 11, such as shingles, to the outer surface of the sub-siding layer 7, abutted against an undersurface of the outer portion 4 of the frame so as to cover the nailing flange 5. The inside of the window housing was finished by securing an inner, lining layer 12b, such as sheet rock or paneling, over the stud portion 6 and optional sub-sill 12a of the housing, abutted against the inside face of the frame, to form a finished interior sill 12b. Sheet rock 12c or the like was used to finish the interior wall of the house.

Aluminum window frames continued to be widely used in new home construction in the United States throughout the 1970's, after which they began to be phased out in favor of more energy efficient, durable and aesthetically appealing double-paned, extruded plastic frames. Along with this new construction boom, a large replacement market for modern plastic frames has developed in recent years, due to wide recognition of the energy efficiency and aesthetic benefits of modern plastic frames over the older, aluminum designs. Accordingly, millions of households across the United States and elsewhere have elected to replace existing aluminum frames with more durable, attractive and energy efficient plastic frames.

Referring to FIG. 2, there are three basic methods for retrofit installation of modern plastic window frames into finished window housings 3 originally designed for the prior art aluminum, single-paned frames 1. The most common method is to simply remove the old frame and install the replacement frame in its place (i.e. so that an inner portion of the replacement frame seats atop the sub-siding 7 and a portion of the stud 6, and abuts, but does not overlap, the inner lining 12a), without modifying the finished housing. However, modern, double-paned plastic window frames are poorly adapted for this type of installation, because the modern frames are considerably wider (standard width about 80 mm) compared to the aluminum frames (variable, but approximately 38 mm). This increased width is necessary to accommodate the double glazing panels and insulating airspace between the panels. Therefore, when modern plastic frames are installed according to the above method, the frame protrudes outwardly far beyond the window housing, creating an awkward external appearance and causing a structurally undesirable weight distribution. Such installation methods, although widely practiced, are discouraged or prohibited by building codes and special utility grants.

Alternative methods for retrofit installation of modern, double-paned window frames into finished window housings 3 include: removing the old aluminum frame and mounting the new frame on top of the existing lining component 12a of the housing. Under this alternative method, the installer must trim back the lining 12b to accommodate a deeper inset and a more flush external appearance of the frame. If the frame is mounted on top of the lining component 12a, the installer must trim out the outer portion (i.e. the lining component 12b and subsiding 7) of the window housing with wood or other filler material, to eliminate gaps between the periphery of the new frame and the lining and sub-siding. This trimming is expensive and can account for a large fraction of the total retrofit installation costs.

It is also believed that some installers are retrofitting the new style vinyl frames on top of the existing aluminum main frame by first removing the existing sash and fixed lite. Extensive on site trimming with wood is still required to cover the sill, jamb and header portions 12b because of the variable width of the existing aluminum main frames 1. Typically, the new vinyl frame is butt-jointed to a piece of wood custom ripped on site to the current width to hide the existing sill, jamb and header lining component 12b. Additional trim pieces must be custom cut to cover gaps between the new butt-jointed liner and the existing liner, as well as for the outside of the new window. These activities are extremely labor intensive and require skilled carpenters, adding significantly to the cost of window renovation.

Yet another problem in the retrofit window industry is the need for a retrofit window frame specifically adapted for replacing aluminum frames installed into stucco-finished window openings. This application poses special problems in that a stucco siding layer covering the nailing flange of the original frame cannot be readily removed to allow for removal and replacement of the original frame. Unlike shingles and other siding materials, stucco must be chipped away from the nailing flange and cannot be easily replaced after removal of the old frame. Due to the high cost of repairing stucco, it is therefore common practice to leave the original aluminum frame in place and to mount the replacement frame over the original frame (i.e. any nailing flanges are removed from the replacement frame and the frame is mounted within the opening bounded by the original frame after its glazing panel and any cross-pieces have been torn out).

However, this installation approach creates an additional problem because the increased width of the replacement frame requires a deep inset so that the replacement frame can extend inward well beyond the inner face of the existing aluminum frame. This mounting arrangement leads to the formation of a gap between the inner portion of the replacement frame and the lining portion of the original window housing. In current practice, this gap is trimmed with wood or other material to fill or mask the gap, resulting in a significant increase in total retrofit installation costs. An additional drawback to this method is that the replacement frame, seated within the aperture defined by the original frame, causes extensive loss of sight and day light by narrowing the glazing panel aperture height and width. Further, to avoid an unsightly external appearance of the window, the frame must be modified by a special flange extending peripherally from the outside of the frame so as to cover the outer face of the original aluminum frame.

In light of the above considerations, a need exists in the retrofit window frame industry for a replacement window frame which offers the benefits of modern, double paned plastic frames, but which is specifically designed for retrofit construction applications. In particular, a need exists for a retrofit window frame which can be inset within finished window housings to provide for flush installation of a wide, double-paned frame, but which does not require removal of the existing aluminum frame nor extensive trimming due to the shallow inset position of the inner lining portion of the housing.

Yet another need exists in the retrofit window industry for a replacement window frame specifically designed to replace aluminum frames in stucco-finished buildings. In particular, a need exists for a replacement frame which mounts over an existing aluminum frame so as to obviate the need for stucco removal, but which does not require expensive trimming to eliminate gaps between the frame and inner lining, and which minimizes loss of sight and day light.

### SUMMARY OF THE INVENTION

It is therefore an object of the present invention to provide a window frame which is specifically designed for retrofit installation into finished window housings.

It is a further object of the invention to achieve the above object in a retrofit window frame which can be inset within finished window housings without removal of the existing frame and which does not require extensive trimming to accommodate the new frame.

It is yet another object of the invention to provide a retrofit window frame specifically designed to replace aluminum frames in stucco-finished window housings. Specifically, it is an object of the invention to provide a replacement frame which mounts over an existing aluminum frame, but which does not create gaps between the frame and lining portion of the housing, and which minimizes loss of sight and day light.

The invention achieves these objects and other objects and advantages which will become apparent from the description which follows by providing a retrofit window frame specially designed for installation into a finished window housing without removing the existing window frame. The finished window housing for which the frame is designed includes an inner, lining component forming an inner mounting aperture, and an outer, stud/sub-siding component forming a larger, outer mounting aperture for the existing frame. The inventive frame defines a closed polygon having forwardly and/or rearwardly (transversely) directed pockets designed to telescopically accept forwardly and/or rearwardly directed cover pieces. These design features allow the window frame to be mounted on the existing window frame while the cover pieces extend inwardly or outwardly to overlap the lining component or the outer portion of the existing frame element.

In a first preferred embodiment of the invention, the frame includes a rearwardly directed pocket for telescopically accepting a window liner to cover an existing sill, header, jamb component of the existing window frame liner. A forwardly directed accessory pocket accepts a downwardly depending lip to cover an outer face of the existing frame component.

In an alternate embodiment of the invention, the window frame is specifically adapted to mount in stucco finished window housings having existing aluminum frame elements remaining in the housing, to obviate the need for removal of the existing frame before installation of the replacement frame. For this application, the invention provides a replacement frame having an inner seating element dimensioned for close receipt within the inner mounting aperture of the housing, and an outer seating element dimensioned for close receipt within an existing frame aperture defined by the existing frame component. These design features allow the frame to extend inward to overlap the lining component, while the outer seating element steps up and overlaps the existing frame element of the housing. In addition, the invention provides a telescopically extendible cowling for covering the existing frame component. The cowling connects to the outer seating element of the frame and telescopes outwardly and peripherally therefrom to cover an outer face of the existing frame component.

### BRIEF DESCRIPTION OF THE DRAWINGS

FIG. 1 is an environmental view showing a portion of a window frame employing the concepts of the invention, mounted in a cutaway portion of a finished window housing.

FIG. 2 is a partial sectional view of a prior art single-paned, aluminum window frame installed in a finished window housing.

FIG. 3 is a partial sectional view of a preferred embodiment of the invention installed in a finished window housing having an existing frame component remaining in the housing.

FIG. 4 is a partial sectional view of an alternate embodiment of the invention installed in a stucco-finished window housing having an existing frame component remaining in the housing.

### DETAILED DESCRIPTION OF THE PREFERRED EMBODIMENTS

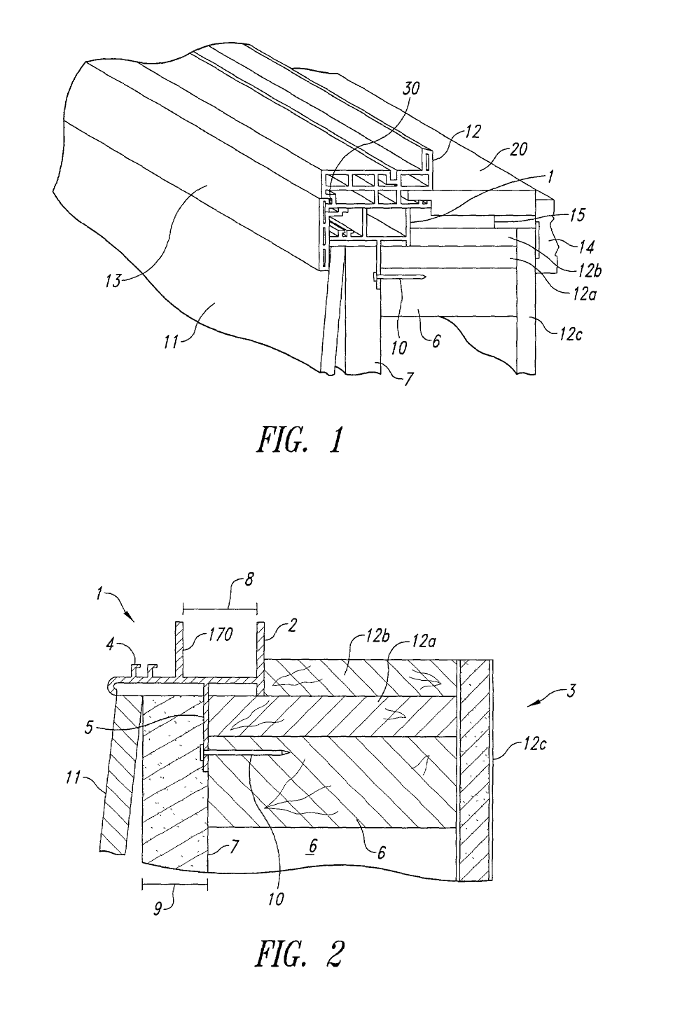

A window frame employing the concepts of the present invention is generally indicated at reference numeral 14 in FIGS. 1, 3 and 4. The frame is specifically designed for installation into a finished window housing generally indicated at reference numeral 3 from which an older design, aluminum window frame generally indicated at reference numeral 1 in FIG. 2, has not been removed. The housing includes an inner sill, jamb or header lining component 12b defining a rectangular, inner mounting aperture (i.e. the rectangular opening bounded by the lining). The window frame in FIG. 1, for example, includes an extant frame 1 (e.g., an aluminum frame from the prior window) which is attached to a framework, comprising: studs 6; subliner 12a; sill, jamb and header liners 12b; external siding 11; insulation 7; and interior sheet rock 12c. The extant frame 1 may extend between the external siding 11 and the internal sill 12b. Typically, the insulation 7 will be positioned just behind the siding.

A replacement window frame may include a main frame 12, which may be adapted to hold one or more panes of glass or the like (not shown). The main frame 12 includes a rearwardly directed, internal peripheral pocket recess or pocket 14 which may extend along just the bottom leg of the frame or, more preferably, about the entire sill, jamb and header lengths of the main frame 12. The recess 14 is sized to telescopically receive a mating projection 22 of a window liner 20. The window liner can be made from a variety of millwork products such as ponderosa pine, or engineered wood fiber/thermoplastic composites or the like.

The window liner 20 in many cases will define a gap 15 with the existing liner 12b. The gap is preferably covered with millwork such as a peripherally extending trim or casing 24. The trim 24 may extend from the window liner 20 to a position abutting the inside wall 12c at a location spaced peripherally outside the liner 20. If so desired, a support (not shown), e.g., a wood shim, may be included between the liner 20 and the sill 12b to support the liner 20.

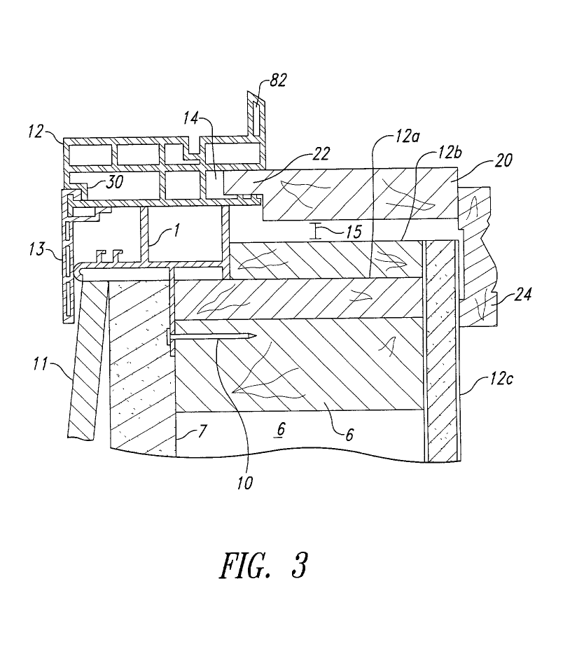

As shown in FIG. 3, the liner 20 and the frame 12 are preferably telescopically adjustable in a transverse direction to accommodate different total wall widths. The frame 12 and liner 20 are preferably separable for shipment to the work site and subsequent adjustment by installers. The relative transverse positions of the frame 12 and liner 20 are fixed by screws, nails or the like (not shown) in the conventional manner.

The shape of the mating projection 22 of the liner 20 may be varied. In one embodiment, it is generally rectangular, as shown. In another embodiment (not shown), it is generally arrow-shaped, having a beveled inner edge to facilitate placement in the recess 14. The length of the mating projection 22 and the depth of the recess 14 can be varied. For example, the recess depth and the length of the projection 22 may be the same and range from about 0.5 inches to about 2 inches. In another embodiment, this depth and length are about 0.75-2 inches. Having this depth and length between about 1 inch and 2 inches should suffice for most applications.

In this preferred embodiment, the main frame 12 also has a conventional accessory pocket 30 on the lower front edge thereof for receiving a downwardly depending cowling 13 for covering a forward portion of the extant frame 1. As used herein, the phrase “transversely directed pocket” also includes the accessory pocket 30.

In some embodiments, the invention provides a method of installing a window. In one such embodiment, the entire original window need not be removed. Instead one need remove only the sliding vent and glass, for example; the remainder of the extant frame 1 may be left intact. This can also enable the user to leave the original siding 11, inside wall 12c and sill 12b intact. The frame 12 of the new window may be inserted in the space defined within the extant frame 1 from the outside window opening. The window liner 20 with trim 24 will be inserted from the inside and the projection 22 will be aligned with and inserted into the recess 14. Calculations from the opening width will determine the variable transverse dimension of the window frame 12/liner 20 combination. Joining this frame and liner by means of this unique mortise and tenon concept may significantly simplify retrofit installations, making such installations less expensive and more cosmetically attractive. As will be appreciated by those of ordinary skill in the art, the telescopic adjustability of the liner 20 with respect to the window frame 12 accommodates a wide variety of existing aluminum frame 1 widths such that only semiskilled labor is required for installation.

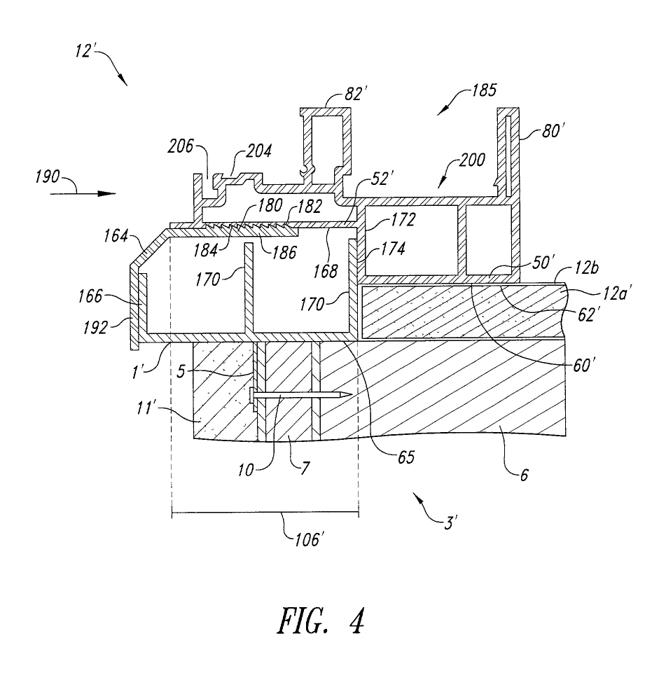

In an alternate embodiment of the invention, a replacement window frame 12′ is specifically adapted to mount in stucco-finished window housings 3′ which have an existing aluminum frame component 1′ remaining in the housing (see FIG. 4). The object of this embodiment is to prevent damage to a stucco siding component 11′ of the housing, which would otherwise have to be removed in the area of the nailing flange 5 if the existing frame 1′ were removed. To meet this objective, the retrofit frame 12′ has an inner seating element 50′ dimensioned for close receipt within an inner mounting aperture defined by a lining component 12a′ of the housing, and an outer seating element 52′ dimensioned for receipt within an existing frame aperture bounded by the existing frame component. In addition, the invention provides a cowling 164 which is telescopically engageable with the stucco housing frame 12′ for covering an outer face 166 of the existing frame component, to enhance the aesthetic appeal of the mounted frame. The cowling connects to the outer seating element 52′ of the frame and extends outwardly and peripherally therefrom to cover the outer face of the existing frame.

The cross-sectional profile of the stucco housing frame 12′ has a multi-level periphery, to conform to the various components of the window housing 3′. Accordingly, height and width dimensions of the inner 50′ and outer 52′ seating elements approximately correspond to height and width dimensions of the inner mounting aperture and existing frame aperture, respectively. After the frame is mounted, a seating surface 60′ of the inner seating element 50′ closely juxtaposes a mounting surface 62′ of the lining component 12a′ of the housing 3′, and a bridging surface 168 of the outer seating element closely juxtaposes inner leg portions 170 of the existing frame component.

An inset depth of the mounted replacement frame 12′ relative to the housing 3′ is determined by a location of an existing frame step junction 172. This junction separates the seating surface 60′ of the inner seating element 50′ and the bridging surface of the outer 52′ seating element of the replacement frame, and juxtaposes an existing frame abutment 174 when the replacement frame is mounted. The existing frame step junction 172 is preferably situated intermediate an inner face 80′ and an outer glazing leg 82′ of the replacement frame, to provide a more flush external appearance and ensure proper weight distribution of the mounted frame.

The purpose of the optional cowling 164 for use with the stucco-housing frame 12′ is to enhance the aesthetics and weather resistance of the frame by more completely covering the existing frame component of the housing. The cowling is designed to extend outwardly and peripherally from the outer seating element 52′ of the replacement frame, to mask the outer face 166 of the existing frame from weather and view exposure. To facilitate installation, it is preferred that the cowling be selectably attachable to the outer seating element of the replacement frame, rather than being formed as part of a unitary frame stock. Therefore, the cowling has a frame-attachment flange 180 with frame mating teeth 182 for engaging complementary, teeth mating grooves 184 in a pocket like area on the bridging surface 168 of the outer seating element to provide the telescoping action. Thus, the outer seating element 52′ and the existing frame 1′ form the transversely directed pocket of this embodiment.

To install the stucco-housing replacement frame 12′ all internal parts, including glazing panels, movable sash elements and cross-supports (not shown), of the existing, aluminum frame 1′ are removed, leaving only the peripheral frame structure (shown in FIG. 2 or 4) remaining in the housing 3′. Next, a partial frame 185 (see FIG. 4) including the inner 50′ and outer 52′ seating elements without the cowling 164 is assembled and mounted. The partial frame is assembled by heat welding appropriate sized sections of frame stock (not shown) into a closed polygon having complementary shape and dimensions to the housing. This base frame is then inserted into the housing from the inside of the housing until the existing frame step junction 172 contacts the existing frame abutment 174. Next, a cowling assembly (not shown), formed of individual stock pieces of cowling 164 cut and welded into a complementary shape to the base frame, is inserted between the outer seating element 52′ of the frame and the existing frame component 1′ of the housing, so that the frame engaging teeth 182 of the cowling engage the teeth mating grooves 184 of the frame. Attachment of the cowling can then be adjusted by advancing the cowling inward (arrow 190) until a peripheral flange 192 of the cowling closely juxtaposes the outer face 166 of the existing frame component 1′. For this purpose, it is preferred that the frame-engaging teeth 182 and teeth-mating grooves 184 be provided in sufficient number to provide for about 10-30 mm of inward adjustability of the cowling, to accommodate different existing frame widths and shapes.

Manufacture of the window frame 12 and its component parts and fittings can be performed using a variety of well known materials and fabrication processes. Preferred materials include plastics, such as polyvinyl and polyurethane materials, and other moldable materials having appropriate durability, hardness and rigidity. A preferred manufacturing process is extrusion, however other molding processes such as injection molding and pulltrusion molding are also suitable.

In addition to the frame structures described above, the frame 12, 12′ of the invention also provides standard structural components for fixedly housing conventional panels of glass or plexiglass materials assembled into fixed-mounted or sliding sash subframes (not shown). Referring to FIG. 4, these secondary frame structures can include conventional sliding tracks for slidably mounting a movable sash (not shown), the outer glazing leg 82, 82′ for mounting fixed outer glazing panels (not shown), and setting blocks 204, glazing stops (or bead pockets) 206 and other components generally used in the industry for securely housing glazing panels. Each of these structural components are preferably designed as integral components of an extruded, base or partial frame stock.

Those with ordinary skill in the art will appreciate that other embodiments and variations of the invention are possible which employ the same inventive concepts described above. By way of example only and not limitation, it is possible to extrude the trim piece 24 and window liner 20 as a single piece to speed field assembly of the retrofit window, thereby eliminating the need for skilled carpenters on site. Therefore, the invention is not to be limited by the above disclosure, but is to be determined in scope by the claims which follow.

I claim:

1. A retrofit window frame for installation into an existing building window housing having an existing window frame component surrounded by an existing lining component, comprising:
a main frame defining a closed polygon for securing a glazing panel within the window housing, the main frame having a transversely directed pocket dimensioned for telescopic receipt of a cover piece;
a transversely extending cover piece for covering one of the existing components; and,
telescopic means for adjusting a transverse dimension of a frame/cover piece assembly, whereby the retrofit frame can be inset within existing window frame component and the retrofit window frame can conform to the window housing without extensive trimming.

2. The retrofit window frame of claim 1, wherein the pocket is rearwardly directed and wherein the cover piece is a window liner and can cover the existing lining component.

3. The retrofit window frame of claim 2, including a peripheral casing abutting an exposed edge of the window liner to conceal any gap between the window liner and the existing lining component in an inside of the existing building window housing.

4. The retrofit window frame of claim 2, wherein the telescopic means is a recess on the main frame and a mating projection on the window liner.

5. The retrofit window frame of claim 2 wherein a front portion of the main frame has a second, forwardly directed pocket for receiving a cowling to cover a portion of the existing window frame.

6. The retrofit window frame of claim 1, wherein the pocket is forwardly directed and is formed by an underside of the main frame and an upper portion of the existing frame.

7. The retrofit window frame of claim 6 wherein the cover piece is a forwardly directed cowling.

8. The retrofit window frame of claim 7 wherein the telescopic means is a series of cooperative teeth on the underside of the main frame and on an upper surface of the cowling.

9. A method for installing a retrofit window frame into a building window housing having an inner lining component defining an inner mounting aperture, and an outer, existing frame component mounted on a stud/subsiding component surrounding the lining component and partially extending outwardly therefrom, the existing frame component defining an existing frame aperture smaller than the inner mounting aperture, comprising the steps of:
providing a main frame for securing a glazing panel within the window opening, the main frame being placed at least partially on the existing frame, the main frame having a transversely directed pocket dimensioned for telescopic receipt of a cover piece; and,
inserting the cover piece into the main frame at least partially within the pocket so that a main frame cover piece assembly substantially overlaps the existing lining component of the window housing and the existing frame component.

10. The method of claim 9, including the step of attaching a cowling to an outer surface of the main frame to cover an outer face of the existing frame component.
